(19) United States
(12) Patent Application Publication
(10) Pub. No.: US 2025/0291452 A1
(43) Pub. Date: Sep. 18, 2025

(54) DISPLAY CONTROL DEVICE AND DISPLAY CONTROL METHOD

(71) Applicant: Panasonic Automotive Systems Co., Ltd., Kanagawa (JP)

(72) Inventors: Junya YUSA, Kanagawa (JP); Masahito OISHI, Kanagawa (JP); Nobutaka KITAJIMA, Osaka (JP); Takami YAMAMOTO, Osaka (JP)

(73) Assignee: Panasonic Automotive Systems Co., Ltd., Kanagawa (JP)

(21) Appl. No.: 19/076,519

(22) Filed: Mar. 11, 2025

(30) Foreign Application Priority Data
Mar. 15, 2024 (JP) 2024-041272

(51) Int. Cl. G06F 3/0481; B60K 35/22

(52) U.S. Cl. CPC G06F 3/0481; B60K 35/22; B60K 2360/11

(57) ABSTRACT

A display control device includes: a screen manager that obtains operation information indicating that a trigger operation has been performed to trigger placement of a second target area allocated to a second application in a display area including at least one first area; and a screen generator that determines, when the operation information is obtained, whether to perform the placement, performs the placement without placing the at least one first area in the display area when it is determined to perform the placement, determines, when one of the at least one first applications is different from the second application in type and it is determined to perform the placement, whether to place a second area allocated to the first application in the display area, and places the second area in the display area, when it is determined to place the second area in the display area.

### CROSS REFERENCE TO RELATED APPLICATION

The present application is based on and claims priority of Japanese Patent Application No. 2024-041272 filed on Mar. 15, 2024.

### FIELD

The present disclosure relates to a display control device and so forth.

### BACKGROUND

In recent years, devices that control displaying of an image onto a display disposed in a vehicle have been disclosed. For example, Patent Literature (PTL) 1 discloses a control device that: causes at least one of a plurality of display devices to display a customization image for which a display screen is customizable; and transmits display content generated based on a display layout customized on the customization image by a user, to each of the plurality of display devices.

### CITATION LIST

### Patent Literature

PTL 1: Japanese Unexamined Patent Application Publication No. 2022-156438

### SUMMARY

However, the control device according to PTL 1 can be improved upon.

In view of this, the present disclosure provides a display control device and so forth capable of improving upon the above related art.

A display control device according to an aspect of the present disclosure includes: an obtainer that obtains operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area; and a controller that determines, when the operation information is obtained by the obtainer, whether to place the second target area in the display area, places, when the second target area is determined to be placed in the display area, the second target area in the display area without placing the at least one first area in the display area, determines, when the second target area is determined to be placed in the display area in presence of a first application that is included among the at least one first application and that is different in type from the second application, whether to place a second area allocated to the first application in the display area, and places, when the second area is determined to be placed in the display area, the second area in the display area.

A display control method according to another aspect of the present disclosure includes: obtaining operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area; determining, when the operation information is obtained in the obtaining, whether to place the second target area in the display area; placing, when the second target area is determined to be placed in the display area, the second target area in the display area without placing the at least one first area in the display area; determining, when the second target area is determined to be placed in the display area in presence of a first application that is included among the at least one first application and that is different in type from the second application, whether to place a second area allocated to the first application in the display area; and placing, when the second area is determined to be placed in the display area, the second area in the display area.

A program according to still another aspect of the present disclosure is a program for causing a computer to execute the display control method described above.

General or specific aspects of the present disclosure may be implemented to a system, a device, an integrated circuit, a computer program, a computer-readable recording medium such as a Compact Disc-Read Only Memory (CD-ROM), or any given combination thereof. The recording medium may be a non-transitory recording medium.

The display control device and so forth according to the present disclosure enable more appropriate use of a display area of a display disposed in a vehicle.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view of a vehicle including a display control device according to Embodiment.

FIG. 2 is a block diagram illustrating a functional configuration including the display control device illustrated in FIG. 1.

FIG. 3 is a flowchart illustrating an example of a display control method executed by the display control device illustrated in FIG. 1.

FIG. 4 is a flowchart continued from FIG. 3.

FIG. 5 is a diagram illustrating an example of application information.

FIG. 6 is a diagram illustrating operation example 1 performed by the display control device illustrated in FIG. 1.

FIG. 7 is a diagram illustrating operation example 2 performed by the display control device illustrated in FIG. 1.

FIG. 8 is a diagram illustrating operation example 3 performed by the display control device illustrated in FIG. 1.

FIG. 9 is a diagram illustrating operation example 4 performed by the display control device illustrated in FIG. 1.

### DESCRIPTION OF EMBODIMENT

It has conventionally been desired to more appropriately use a display area of a display disposed in a vehicle. In view of this, the present disclosure provides a display control device and so forth that enable more appropriate use of a display area of a display disposed in a vehicle.

A display control device according to an aspect of the present disclosure includes: an obtainer that obtains operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area; and a controller that determines, when the operation information is obtained by the obtainer, whether to place the second target area in the display area, places, when the second target area is determined to be placed in the display area, the second target area in the display area without placing the at least one first area in the display area, determines, when the second target area is determined to be placed in the display area in presence of a first application that is included among the at least one first application and that is different in type from the second application, whether to place a second area allocated to the first application in the display area, and places, when the second area is determined to be placed in the display area, the second area in the display area.

With this, the second area that is allocated to the second application different from the at least one first application and that is different from the at least one first area is placeable in the display area. This allows the display area to be used more appropriately. Furthermore, the second area allocated to the first application that is included among the at least one first application and that is different in type from the second application is placeable in the display area. This allows the display area to be used more appropriately.

In the display control device according to the aspect of the present disclosure, it is possible that each of the at least one first application and the second application is assigned a priority, and the controller determines, when the at least one first application includes a priority application that is a first application having the priority higher than the priority of the second application, whether the second target area and a priority area that is the second area allocated to the priority application are placeable in the display area, determines, when determining that the priority area and the second target area are placeable in the display area, to place the priority area and the second target area in the display area, and when determining that the priority area and the second target area are not placeable in the display area, determines not to place the priority area and the second target area in the display area and places the at least one first area in the display area.

With this, when the priority area and the second target area are placeable in the display area, the priority area and the second target area are placed in the display area. When the priority area and the second target area are not placeable in the display area, the at least one first area is placed in the display area instead of placing the priority area and the second target area in the display area. This allows the display area to be used even more appropriately.

In the display control device according to the aspect of the present disclosure, it is possible that the controller determines, when the at least one first application includes a non-priority application that is a first application having the priority that is not higher than the priority of the second application, whether a non-priority area that is the second area allocated to the non-priority application is placeable in a first extra area that is included in the display area and in which neither the priority area nor the second target area is placed, and determines, when determining that the non-priority area is placeable in the first extra area, to place the non-priority area in the first extra area.

With this, when the non-priority area is placeable in the first extra area, the non-priority area is placed in the first extra area. This allows the display area to be used even more appropriately.

In the display control device according to the aspect of the present disclosure, it is possible that when the display area includes a second extra area in which none of the priority area, the second target area, or the non-priority area is placed in presence of a third application other than the at least one first application and the second application, the controller determines whether a third area allocated to the third application is placeable in the second extra area and places the third area in the second extra area when the third area is determined placeable in the second extra area.

With this, when the third area is placeable in the second extra area, the third area is placed in the second extra area. This allows the display area to be used even more appropriately.

In the display control device according to the aspect of the present disclosure, it is possible that the trigger operation is performed to replace a first application among the at least one first application with the second application that is of a same type as the first application, the second target area is smaller than a first target area in which the first area allocated to the first application was placed, and when the second target area is determined to be placed in the display area, the controller causes the second target area to be included in the first target area in the display area.

With this, the second target area that is smaller than the first target area can be placed to be included in the first target area.

In the display control device according to the aspect of the present disclosure, it is possible that the trigger operation is performed to replace a first application among the at least one first application with the second application that is of a same type as the first application, the second target area is larger than a first target area in which the first area allocated to the first application was placed, and when the second target area is determined to be placed in the display area, the controller causes the first target area to be included in the second target area in the display area.

With this, the second target area that is larger than the first target area can be placed to include the first target area.

In the display control device according to the aspect of the present disclosure, it is possible that each of the at least one first application and the second application has a display-position constraint, and whether to place the second target area or the second area in the display area is determined based on whether placement of the second target area or the second area in the display area satisfies the display-position constraint.

With this, when the placement of the second target area or the second area satisfies the display-position constraint, the second target area or the second area is placeable in the display area. This allows the display area to be used even more appropriately.

In the display control device according to the aspect of the present disclosure, it is possible that the at least one first area comprises a plurality of first areas arranged in a predetermined direction, and the display-position constraint is a constraint on a range within which a center position of the second target area or the second area in the predetermined direction is located.

With this, when the placement of the second target area or the second area satisfies the constraint on the range within which the center position of the second target area or the second area in the predetermined direction is located, the second target area or the second area is placeable in the display area. This allows the display area to be used even more appropriately.

In the display control device according to the aspect of the present disclosure, it is possible that the display-position constraint is a constraint on a positional relationship between the second target area and the second area or a positional relationship between second areas each being the second area.

With this, when the placement of the second target area or the second area satisfies the constraint on the positional relationship between the second target area and the second area or the positional relationship between the second areas, the second target area or the second area is placeable in the display area. This allows the display area to be used even more appropriately.

In the display control device according to the aspect of the present disclosure, it is possible that each of the at least one first application and the second application has a required area that indicates an area size required for displaying, and

when the required area is different in size from the second target area or the second area, the controller enlarges or reduces a screen to be displayed by the first application or the second application.

With this, when the required area is different in size from the second target area or the second area, the screen displayed by the first application or the second application can be enlarged or reduced before being displayed. This allows the display area to be used even more appropriately.

In the display control device according to the aspect of the present disclosure, it is possible that the vehicle includes: a driver seat on one side with respect to a central part of the vehicle in a transverse direction of the vehicle; and a passenger seat on an other side with respect to the central part of the vehicle in the transverse direction, the predetermined direction is the transverse direction, and the display area is: located farther forward than the driver seat and the passenger seat in a longitudinal direction of the vehicle; located in front of the driver seat and the passenger seat, extending from a position corresponding to the driver seat to a position corresponding to the passenger seat in the transverse direction; and disposed to face rearward in the longitudinal direction.

This allows the second target area to be easy to see for a driver of the vehicle and allows the second area to be easy to see for a passenger of the vehicle.

A display control method according to another aspect of the present disclosure includes: obtaining operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area; determining, when the operation information is obtained in the obtaining, whether to place the second target area in the display area; placing, when the second target area is determined to be placed in the display area, the second target area in the display area without placing the at least one first area in the display area; determining, when the second target area is determined to be placed in the display area in presence of a first application that is included among the at least one first application and that is different in type from the second application, whether to place a second area allocated to the first application in the display area; and placing, when the second area is determined to be placed in the display area, the second area in the display area.

With this, the same operational effects as those achieved by the display control device described above can be achieved.

A program according to still another aspect of the present disclosure is a program for causing a computer to execute the display control method described above.

With this, the same operational effects as those achieved by the display control device described above can be achieved.

Hereinafter, certain exemplary embodiments will be described in detail with reference to the accompanying

### DRAWINGS

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

### Embodiment

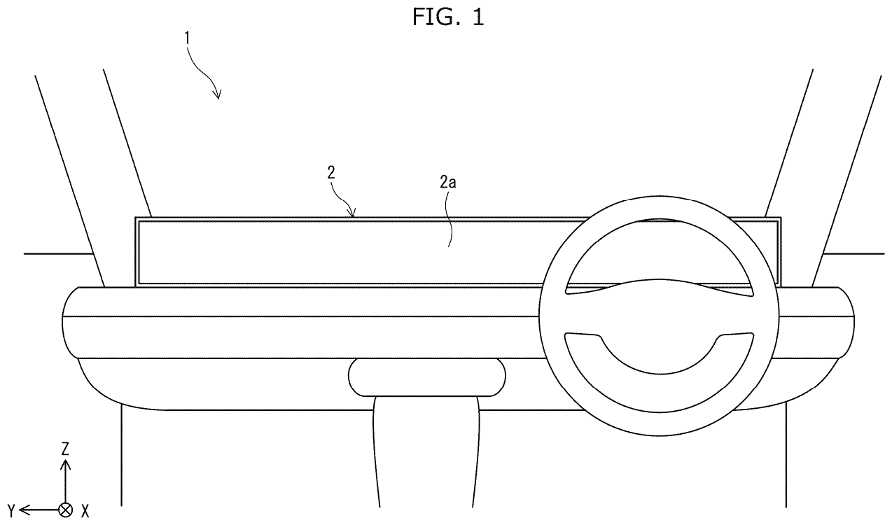

FIG. 1 is a schematic view of vehicle 1 including display control device 10 (described later) according to Embodiment. Vehicle 1 is first described with reference to FIG. 1.

In FIG. 1, the X-axis direction indicates the longitudinal direction of vehicle 1. The positive side in the X-axis direction indicates the front side, and the negative side in the X-axis direction indicates the rear side. The Y-axis direction indicates the transverse direction of vehicle 1. The positive side in the Y-axis direction indicates the left side, and the negative side in the Y-axis direction indicates the right side. The Z-axis direction indicates the vertical direction of vehicle 1. The positive side in the Z-axis direction indicates the upper side, and the negative side in the Z-axis direction indicates the lower side.

In the following description, the longitudinal direction of vehicle 1 may be referred to simply as the longitudinal direction for short, and the transverse direction of vehicle 1 may be referred to simply as the transverse direction for short. Furthermore, the vertical direction of vehicle 1 may be referred to simply as the vertical direction for short.

As illustrated in FIG. 1, display 2 that displays an image is disposed in vehicle 1. Vehicle 1 is an automobile, for example. Vehicle 1 includes: a driver seat on one side with respect to a central part of vehicle 1 in the transverse direction; and a passenger seat on the other side of the central part of vehicle 1 in the transverse direction.

Display 2 is a display, for example, and is disposed inside vehicle 1. Display area 2a of display 2 is located farther forward than the driver seat and the passenger seat in the longitudinal direction. Display area 2a is located in front of the driver seat and the passenger seat, extending in the transverse direction from a position corresponding to the driver seat to a position corresponding to the passenger seat. More specifically, display area 2a extends in the transverse direction, from one side with respect to the central part of vehicle 1 to the other side with respect to the central part of vehicle 1 in the transverse direction. Display area 2a is disposed to face rearward in the longitudinal direction. This allows a driver in the driver seat and a passenger in the passenger seat to view an image displayed on display area 2a. Display area 2a is rectangular. Display area 2a of display 2 is an area on which an image is displayable. In the present embodiment, display 2 is disposed on a dashboard of vehicle 1.

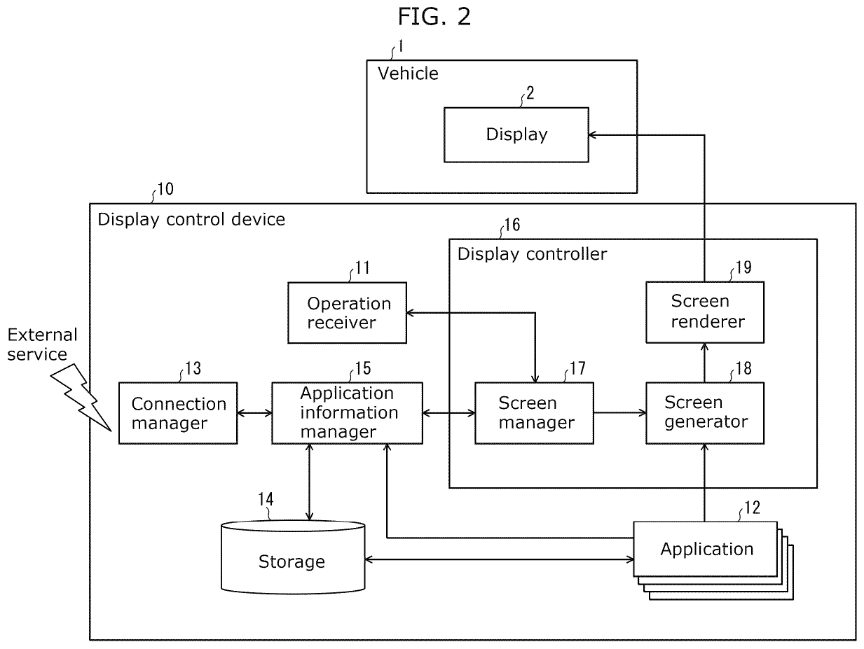

FIG. 2 is a block diagram illustrating a functional configuration including display control device 10 illustrated in FIG. 1. The functional configuration of display control device 10 is next described with reference to FIG. 2.

As illustrated in FIG. 2, display control device 10 includes operation receiver 11, a plurality of applications 12, connection manager 13, storage 14, application information manager 15, and display controller 16. For example, operation receiver 11 is implemented by a touch panel or hardware buttons, and storage 14 is implemented by a memory. Connection manager 13, application information manager 15, and display controller 16 are implemented by a processor, for example.

Operation receiver 11 receives a trigger operation that triggers placement of a second target area in display area 2a that is included in display 2 disposed in vehicle 1 and that includes at least one first area allocated to at least one first application, the second target area being allocated to a second application different from the at least one first application and being different from the at least one first area. The second application may be of the same type as the at least one first application or of a different type from the at least one first application. Operation receiver 11 is disposed in vehicle 1. The trigger operation is performed by the driver or the passenger of vehicle 1, for example.

Each of the at least one first application is application 12 selected from among the plurality of applications 12. Each of the at least one first area displays a screen used for achieving a corresponding function of application 12 allocated to this first area.

Each of the plurality of applications 12 is a piece of application software. For example, the plurality of applications 12 include: meter application software for displaying the speed of vehicle 1 and the engine revolutions of vehicle 1; navigation application software for navigating traveling of vehicle 1; surveillance-camera application software for displaying a received image captured by a surveillance camera; music application software for playing back music; and calling application software for receiving a call from, or placing a call to, another party. The plurality of applications 12 are downloaded to display control device 10 beforehand by a user, for example, and are usable via display control device 10.

Connection manager 13 manages communication connection for receiving an external service. Examples of the external service include a service that provides application software. To receive the external service, connection manager 13 establishes wireless communication connection. This allows display control device 10 to download the application software provided by the external service. The application software provided by the external service and downloaded to display control device 10 is stored as application 12 in display control device 10, and is usable via display control device 10.

Storage 14 stores application information, for example.

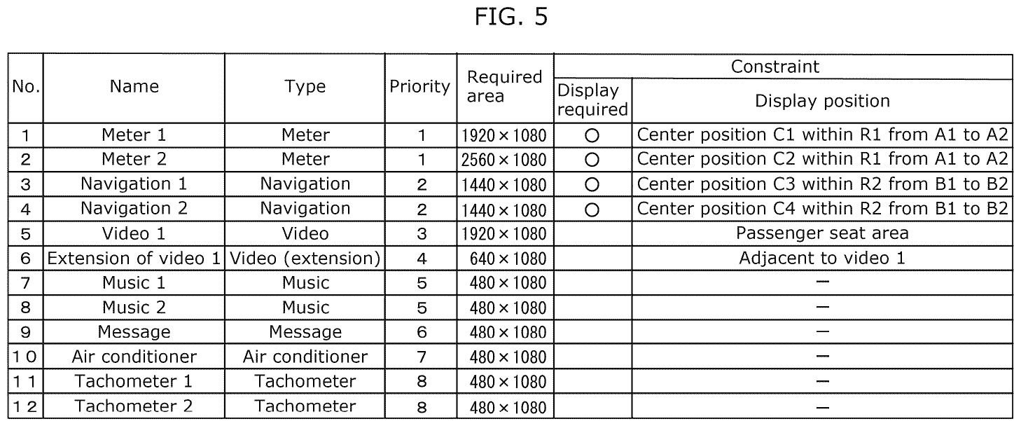

FIG. 5 is an explanatory diagram of an example of the application information to illustrate the example of the application information. In FIG. 5, the application information on applications 12 numbered No. 1 to No. 12 is shown. The application information includes: name of application 12; type of application 12; priority set on application 12; size of area required (that is, required area) to display a screen for achieving the function of application 12; constraint on application 12; and information on design for each of at least one screen displayable by application 12. Examples of the constraint on application 12 include a constraint that the area allocated to application 12 needs to be in display area 2a and a constraint that the area allocated to application 12 needs to be fixed (or more specifically, a display-position constraint). For example, the display-position constraint indicates: a range within which the center position of the area allocated to application 12 in the transverse direction of display area 2a is located; a predetermined position of the area allocated to application 12, such as a position in front of the passenger seat; or a positional relationship with a specific application (for example, adjacent to a specific application). For example, the range within which the center position is located refers to a distance measured from a position specified as the starting point. In FIG. 5, music 1 and music 2 are of the same application (the same type) and are different in design of display screen. Moreover, in FIG. 5, music 1 is selected beforehand by the user.

Referring back to FIG. 2, application information manager 15 manages the application information. For example, application information manager 15 manages: application information on application 12 downloaded to display control device 10; application information stored in storage 14; and application information on application software provided by the external service.

Display controller 16 includes screen manager 17, screen generator 18, and screen renderer 19.

Screen manager 17 is an example of an obtainer that obtains operation information indicating that the trigger operation has been performed. When receiving the trigger operation, operation receiver 11 transmits the operation information to screen manager 17. Thus, screen manager 17 obtains the operation information from operation receiver 11. Based on the operation received by operation receiver 11, screen manager 17 obtains necessary application information from application information manager 15 and then manages the screen displayed by application 12 on display area 2a.

Screen generator 18 is an example of a controller. Screen generator 18 makes a determination of placement of an area on display area 2a, according to the application information. When screen manager 17 obtains the operation information, screen generator 18 determines whether to place the second target area in display area 2a. When determining to place the second target area in display area 2a, screen generator 18 places the second target area in display area 2a without placing the at least one first area in display area 2a. When determining to place the second area in display area 2a in the presence of a first application that is included among the at least one first application and that is different in type from the second application, screen generator 18 determines whether to place the second area allocated to this first application in display area 2a. When determining to place the second area in display area 2a, screen generator 18 places the second area in display area 2a. Screen generator 18 places the second target area and the second area in display area 2a by: determining respective positions in which the second target area and the second area are to be placed in display area 2a; generating a screen on which the second target area and the second area are placed in the determined positions; and causing this screen to be transmitted to display 2 via screen renderer 19 and then to be rendered in display area 2a.

Screen renderer 19 transmits the screen generated by screen generator 18 to display 2 and causes this screen to be rendered and displayed on display area 2a. As a result, the second target area and the second area are placed in display area 2a as described above. For example, screen renderer 19 is communicatively connected to display 2 by wire or wirelessly, and transmits the screen to display 2 to cause the screen to be rendered.

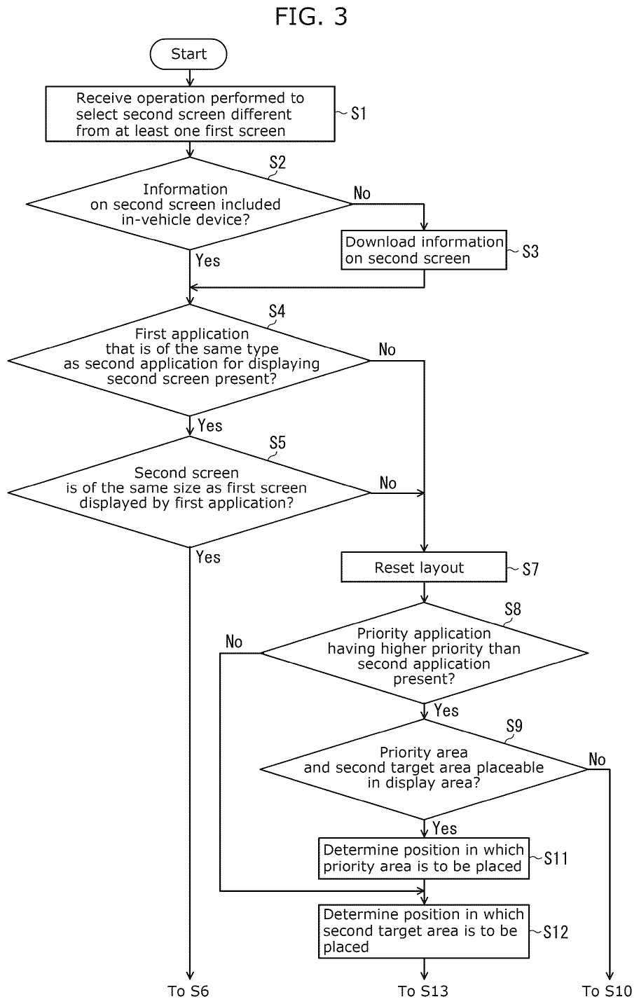

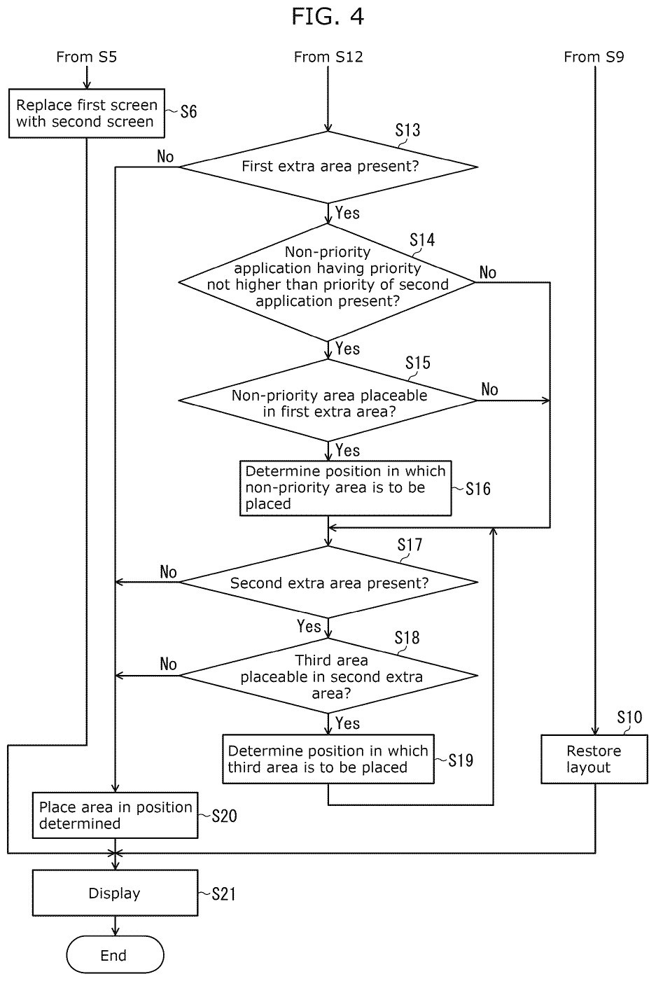

FIG. 3 is a flowchart illustrating an example of a display control method executed by display control device 10 illustrated in FIG. 1. FIG. 4 is a flowchart continued from FIG. 3. The example of the display control method executed by display control device 10 is next described with reference to FIG. 3 and FIG. 4.

The at least one first area allocated to the at least one first application is placed in display area 2a.

As illustrated in FIG. 3, operation receiver 11 receives a selection operation performed to select a second screen that is different from at least one first screen displayed in the at least one first area (Step S1).

Screen manager 17 determines whether an in-vehicle device of vehicle 1 includes information on the second screen (Step S2). The information on the second screen indicates a design of the second screen, a size of an area required to display the second screen, and a display position of the second screen. For example, when the application information on the second application for displaying the second screen is included in the in-vehicle device, screen manager 17 determines that the in-vehicle device includes the information on the second screen. In contrast, when the application information on the second application for displaying the second screen is not included in the in-vehicle device, screen manager 17 determines that the in-vehicle device does not include the information on the second screen. The in-vehicle device includes display control device 10, for example.

When the in-vehicle device does not include the information on the second screen (No in Step S2), connection manager 13 downloads the information on the second screen (Step S3). For example, connection manager 13 downloads the information on the second screen by downloading the second application for displaying the second screen from the external service. The information on the second screen is included in the application information on the second application for displaying the second screen.

Screen generator 18 determines whether the first application that is of the same type as the second application for displaying the second screen is present (Step S4).

When the first application that is of the same type as the second application for displaying the second screen is present (Yes in Step S4), screen generator 18 determines whether the second screen is of the same size as the first screen displayed by this first application (Step S5).

When the second screen is of the same size as the first screen displayed by the first application (Yes in Step S5), screen generator 18 replaces this first screen with the second screen as illustrated in FIG. 4 (Step S6). As a result, screen generator 18 causes the second screen to be displayed together with a first screen other than the aforementioned first screen in display area 2a (Step S21).

As illustrated in FIG. 3, when the at least one first application does not include an application that is of the same type as the second application for displaying the second screen (No in Step S4), screen generator 18 resets the layout (Step S7). Furthermore, when the second screen is not of the same size as the first screen displayed by the first application that is of the same type as the second application (No in Step S5), screen generator 18 resets the layout (Step S7). When the at least one first application does not include an application that is of the same type as the second application for displaying the second screen, or more specifically, when the second application is of a different type from the at least one first application, the selection operation in Step S1 is a trigger operation. Furthermore, when the second screen is not of the same size as the first screen displayed by the first application that is of the same type as the second application, the selection operation in Step S1 is a trigger operation. Here, resetting the layout means not placing the at least one first area in display area 2a.

Screen generator 18 determines whether the at least one first application includes a priority application having a priority higher than a priority of the second application (Step S8). The at least one first application and the second application are assigned respective priorities. Based on these priorities, screen generator 18 determines whether the priority application is present. Note that any first application that is of the same type as the second application and that has the same priority as the second application is not subject to this determination.

When the priority application having the priority higher than the priority of the second application is present (Yes in S8), screen generator 18 determines whether the second target area and a priority area that is the second area allocated to the priority application are placeable in display area 2a (Step S9). For example, when the total size of the priority area having the same size as the first area allocated to the priority application and the second target area having the same size as the second screen is smaller than or equal to the size of display area 2a, screen generator 18 determines that the priority area and the second target area are placeable in display area 2a. In contrast, when the total size of the priority area having the same size as the first area allocated to the priority application and the second target area having the same size as the second screen is larger than the size of display area 2a, screen generator 18 determines that the priority area and the second target area are not placeable in display area 2a. For example, when a plurality of priority areas are present, whether the plurality of priority areas and the second target area are placeable in display area 2a is determined.

As illustrated in FIG. 4, when the priority area and the second target area are not placeable in display area 2a (No in Step S9), screen generator 18 determines not to place the priority area and the second target area in display area 2a and restores the layout (Step S10). Then, screen generator 18 causes the at least one first screen to be displayed in the at least one first area (Step S21). Here, restoring the layout means placing the at least one first area in display area 2a.

As illustrated in FIG. 3, when the priority area and the second target area are placeable in display area 2a (Yes in Step S9), screen generator 18 determines to place the priority area and the second target area in display area 2a. Then, screen generator 18 determines the position where the priority area is to be placed in display area 2a, according to the application information (Step S11). For example, to place the priority area allocated to the priority application and having the same size as the first area that was allocated to the priority application into a position corresponding to the position in which this first area was placed, screen generator 18 determines the position where the priority area is to be placed in display area 2a.

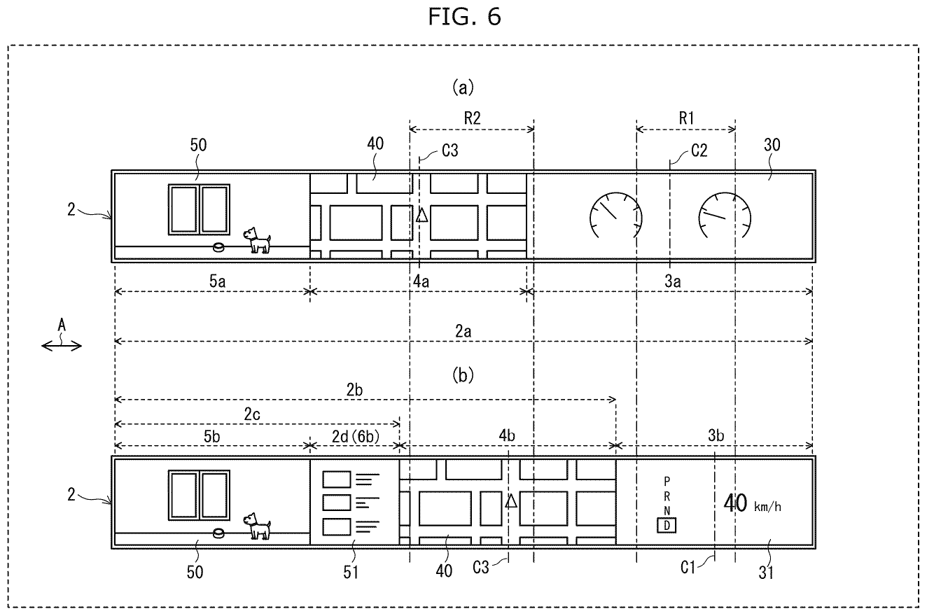

After determining the position where the priority area is to be placed in display area 2a, screen generator 18 determines the position where the second target area is to be placed in display area 2a (Step S12). When a priority application having a priority higher than the priority of the second application is not present (No in Step S8), screen generator 18 determines to place the second target area in display area 2a. Then, screen generator 18 determines the position where the second target area is to be placed in display area 2a (Step S12). How to determine the position where the second target area is to be placed in display area 2a is described later with reference to FIG. 6 to FIG. 9.

As illustrated in FIG. 4, when determining the position where the second target area is to be placed in display area 2a, screen generator 18 determines whether there is a first extra area (Step S13). The first extra area of display area 2a is an area where neither the priority area nor the second target area is placed.

When there is no first extra area (No in Step S13), screen generator 18 places the second target area in the determined position in display area 2a (Step S20). Then, screen generator 18 causes the second screen to be displayed in the second target area placed in display area 2a (Step S21).

When there is the first extra area (Yes in Step S13), screen generator 18 determines whether a non-priority application having a priority not higher than the priority of the second application is present (Step S14). The at least one first application and the second application are assigned respective priorities. Based on these priorities, screen generator 18 determines whether the non-priority application is present.

When the non-priority application having the priority not higher than the priority of the second application is present (Yes in Step S14), screen generator 18 determines whether a non-priority area that is the second area allocated to the non-priority application is placeable in the first extra area (Step S15). For example, when a size of the non-priority area having the same size as the first area that was allocated to the non-priority application is smaller than or equal to the size of the first extra area, screen generator 18 determines that the non-priority area is placeable in the first extra area. In contrast, when the size of the non-priority area having the same size as the first area that was allocated to the non-priority application is larger than the size of the first extra area, screen generator 18 determines that the non-priority area is not placeable in the first extra area. For example, when a plurality of non-priority areas are present and all of the plurality of non-priority areas are not placeable in the first extra area, a non-priority area having a higher priority among the plurality of non-priority areas may be placed preferentially in the first extra area.

When the non-priority area is placeable in the first extra area (Yes in Step S15), screen generator 18 determines the position where the non-priority area is to be placed in the first extra area (Step S16). How to determine the position where the non-priority area is to be placed in the first extra area is described later with reference to FIG. 6 to FIG. 9.

After determining the position where the non-priority area is to be placed in the first extra area, screen generator 18 determines whether there is a second extra area (Step S17). Moreover, when a non-priority application is not present (No in Step S14), screen generator 18 determines whether there is a second extra area (Step S17). Furthermore, when the non-priority area is not placeable in an extra area (No in Step S15), screen generator 18 determines whether there is a second extra area (Step S17). The second extra area of display area 2a is an area where none of the priority area, the second target area, and the non-priority area is placed.

When there is no second extra area (No in Step S17), screen generator 18 places the second target area in the determined position in display area 2a (Step S20). Then, screen generator 18 causes the second screen to be displayed in the second target area placed in display area 2a (Step S21).

When there is the second extra area (Yes in Step S17), screen generator 18 determines whether a third area is placeable in the second extra area (Step S18).

When the third area is not placeable (No in Step S18), screen generator 18 places the second target area in the determined position in display area 2a (Step S20). Then, screen generator 18 causes the second screen to be displayed in the second target area placed in display area 2a (Step S21).

When the third area is placeable (Yes in Step S18), screen generator 18 determines the position where the third area is to be placed in the second extra area (Step S19). Then, screen generator 18 redetermines whether there is a second extra area (Step S17). The third area is an area allocated to a third application other than the at least one first application and the second application. For example, the third application is application 12 selected from among the plurality of applications 12 and is capable of displaying a third screen having a size smaller than or equal to the size of the third area. Note that when no third application is present, Steps S17, S18, and S19 are not performed.

FIG. 6 to FIG. 9 are diagrams illustrating operation examples 1 to 4 performed by display control device 10 illustrated in FIG. 1. Operation examples 1 to 4 are next described with reference to FIG. 6 to FIG. 9. In operation examples 1 to 4, a vertical dimension of the area required for the screen displayed by the application is equal to the vertical dimension of display area 2a.

Note that which of operation examples 1 to 4 is to be performed by display control device 10 is predetermined by the user, for example.

### Operation Example 1

In (a) of FIG. 6, a plurality of areas 3a, 4a, and 5a (the at least one first area) are laid out. Screen 30 displayed by meter 2 is placed in area 3a. Screen 40 displayed by navigation 1 is placed in area 4a. Screen 50 displayed by video 1 is placed in area 5a. In (b) of FIG. 6, a plurality of areas including area 3b (the second target area), area 4b (the non-priority area), area 5b (the non-priority area), and area 6b (the third area) are laid out. Screen 31 displayed by meter 1 is placed in area 3b. Screen 40 displayed by navigation 1 is placed in area 4b. Screen 50 is placed in area 5b. Screen 51 displayed by an extension of video 1 is placed in area 6b.

Operation example 1 performed by display control device 10 is first described with reference to FIG. 6. FIG. 6 is a diagram illustrating an operation example where the user performs an operation to change the application for displaying the meter from meter 2 to meter 1. In this case, meter 2, navigation 1, and video 1 are the first applications, and meter 1 is the second application.

In the present example, the trigger operation is performed to change screen 30 displayed by meter 2, to which area 3a was allocated, to screen 31 displayed by meter 1 and different in size from screen 30 (area 3a).

As illustrated in (a) of FIG. 6, the plurality of areas 3a, 4a, and 5a are arranged in a predetermined direction (see arrow A in FIG. 6, for example). In the present example, the predetermined direction is the transverse direction of vehicle 1. One side in the predetermined direction (or more specifically, area 3a side in relation to area 5a illustrated in (a) of FIG. 6) refers to one side in the transverse direction. Area 3a is the farthest to the one side in the predetermined direction, among the plurality of areas 3a, 4a, and 5a. The plurality of areas 3a, 4a, and 5a are arranged across the whole of display area 2a. Each of the plurality of areas 3a, 4a, and 5a is rectangular, and the other areas are also rectangular. In FIG. 6, an area on the left side in the transverse direction is referred to as a passenger seat area. Furthermore, each of ranges R1 and R2 within which a corresponding center position is located indicates a certain distance measured from, as the starting point, one end of display area 2a.

As indicated by the application information in FIG. 5, meter 2 to which area 3a is allocated has the highest priority among the plurality of applications to which the plurality of areas 3a, 4a, and 5a are allocated. In area 3a, center position C2 of screen 30 is located within range R1 from A1 to A2 under a display constraint of meter 1. Moreover, in area 4a, center position C3 of screen 40 is located within range R2 from B1 to B2 under a display constraint of navigation 1. Furthermore, screen 50 is displayed in area 5a under a display-position constraint that video 1 is displayed in the passenger seat area.

When the plurality of areas 3a, 4a, and 5a are laid out in display area 2a and screen manager 17 obtains the operation information, screen generator 18 determines whether the in-vehicle device includes information on screen 31. Based on the application information, it is determined that the in-vehicle device includes the information on screen 31 of meter 1. Furthermore, it is determined that although meter 1 for displaying screen 31 is of the same type as meter 2 that is one of the first applications, screen 31 is different in size from screen 30. Thus, screen generator 18 determines to reset the layout. Meter 1 has the highest priority among meter 1, navigation 1, and video 1. Thus, screen generator 18 determines whether to place area 3b required to display screen 31 in display area 2a. When area 3b is placeable in display area 2a under the display-position constraint of meter 1, screen generator 18 determines to place area 3b in display area 2a. In the present example as described, whether to place area 3b in display area 2a is determined based on whether the placement of area 3b satisfies the display-position constraint. Screen generator 18 determines whether the placement of area 3b satisfies the display-position constraint. When determining that the placement of area 3b satisfies the display-position constraint, screen generator 18 determines to place area 3b in display area 2a.

When determining to place area 3b in display area 2a, screen generator 18 places area 3b in display area 2a as illustrated in (b) of FIG. 6. In the present example, area 3b is smaller than the first target area in which area 3a was placed. Thus, screen generator 18 causes area 3b to be included in the first target area in display area 2a. To be more specific, although the end part on the one side of area 3b in the predetermined direction is positioned at the end part on the one side of the first target area, center position C1 of area 3b is within range R1 defined by the display-position constraint, as illustrated in (b) of FIG. 6. Thus, screen generator 18 places area 3b in display area 2a. Here, the areas other than area 3b in display area 2a correspond to extra area 2b (the first extra area). In the present example as described, the display-position constraint includes a constraint on the range within which center position C1 of area 3b in the predetermined direction is located. Thus, area 3b is placed to satisfy the display-position constraint. More specifically, center position C1 of area 3b is located within range R1.

Screen generator 18 determines to place navigation 1 and video 1 that are different from meter 1 and are non-priority applications having priorities not higher than the priority of meter 1. In this case, the priority of navigation 1 is higher than the priority of video 1, and thus screen generator 18 first determines to place navigation 1. When center position C3 of area 4b allocated to navigation 1 to which area 4a adjacent to area 3a was allocated can be within range R2 in extra area 2b (the first extra area), screen generator 18 determines to place area 4b in display area 2a. To be more specific, when placing area 4b in extra area 2b (the first extra area), screen generator 18 causes the end part on the one side of area 4b in the predetermined direction to be positioned at the end part on the one side of extra area 2b. In the present example as described, whether to place area 4b in display area 2a is determined based on whether the placement of area 4b satisfies the display-position constraint. Screen generator 18 determines whether the placement of area 4b satisfies the display-position constraint. When determining that the placement of area 4b satisfies the display-position constraint, screen generator 18 determines to place area 4b in display area 2a. The display-position constraint includes a constraint on the range within which center position C3 of area 4b in the predetermined direction is located. Thus, center position C3 of area 4b is located within range R2. Note that the display-position constraint may include a constraint on a positional relationship between the second target area and the second area, for example. To be more specific, the display-position constraint may include a constraint that a positional relationship between area 3b and area 4b corresponds to a positional relationship between area 3a and area 4a. In this case, area 4b can be placed adjacent to the other side of area 3b in the predetermined direction.

Screen generator 18 determines to place video 1, to which area 5a was allocated, in extra area 2c where area 4b is not displayed in extra area 2b. To be more specific, under the display-position constraint that video 1 is displayed in the passenger seat area, screen generator 18 places area 5b at the end part on the other side of extra area 2c. In the present example as described, whether to place area 5b in display area 2a is determined based on whether the placement of area 5b satisfies the display-position constraint. Screen generator 18 determines whether the placement of area 5b satisfies the display-position constraint. When determining that the placement of area 5b satisfies the display-position constraint, screen generator 18 determines to place area 5b in display area 2a. Area 5b is placed to satisfy the display-position constraint.

After area 5b is placed in extra area 2c, there is still extra area 2d (the second extra area). Thus, based on the application information, screen generator 18 determines whether area 6b required to display screen 51 displayed by an extension application of vide 1 that has the next highest priority among applications 12 is placeable in extra area 2d. In this case, area 6b is placeable in extra area 2d under the display-position constraint that area 6b is adjacent to video 1. Thus, screen generator 18 places area 6b in extra area 2d that is adjacent to area 5b. In the present example as described, whether to place area 6b in display area 2a is determined based on whether the placement of area 6b satisfies the display-position constraint.

Screen generator 18 determines whether the placement of area 6b satisfies the display-position constraint. When determining that the placement of area 6b satisfies the display-position constraint, screen generator 18 determines to place area 6b in display area 2a. Area 6b is placed to satisfy the display-position constraint.

In operation example 1, display area 2a after the trigger operation includes: area 3b displaying screen 31 displayed by meter 1; area 4b displaying screen 40 displayed by navigation 1; area 5b displaying screen 50 displayed by video 1; and area 6b displaying screen 51 displayed by the extension of video 1.

In operation example 1, when the screen displayed by the application (meter 2) that is to be changed is larger than the screen displayed by the application (meter 1) that is to be used after the change, an extra area can be allocated as an area for displaying an application that was not displayed before the change.

### Operation Example 2

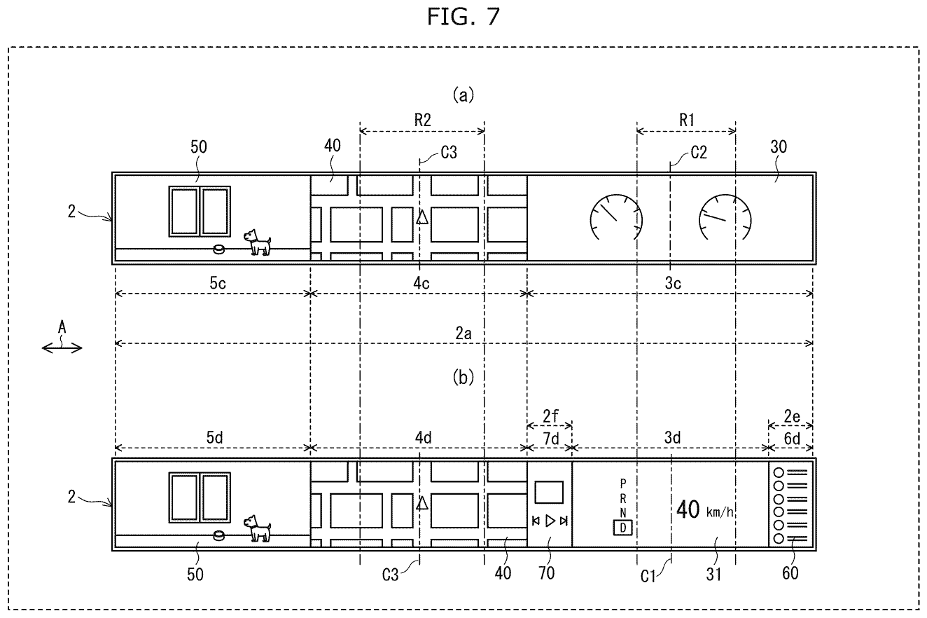

In (a) of FIG. 7, a plurality of areas 3c, 4c, and 5c (the at least one first area) are laid out. Screen 30 displayed by meter 2 is placed in area 3c. Screen 40 displayed by navigation 1 is placed in area 4c. Screen 50 displayed by video 1 is placed in area 5c. In (b) of FIG. 6, a plurality of areas including area 3d (the second target area), area 4d (the non-priority area), area 5d (the non-priority area), area 6d (the third area), and area 7d (the third area) are laid out. Screen 31 displayed by meter 1 is placed in area 3d. Screen 40 is placed in area 4d. Screen 50 is placed in area 5d. Screen 60 displayed by Message is placed in area 6d. Screen 70 displayed by music 1 is placed in area 7d. Operation example 2 performed by display control device 10 is next described with reference to FIG. 7.

FIG. 7 is a diagram illustrating an operation example where the user performs an operation to change the application for displaying the meter from meter 2 to meter 1. In the present example, the trigger operation is performed to change screen 30 displayed by meter 2, to which area 3c was allocated, to screen 31 displayed by meter 1 and different in size from screen 30.

Operation example 2 is different from operation example 1 mainly in the following respects.

When determining to place area 3d in display area 2a, screen generator 18 places area 3d in display area 2a as illustrated in (b) of FIG. 7. In the present example, area 3d is smaller in size than the first target area in which area 3c was placed. Thus, screen generator 18 causes area 3d to be included in the first target area in in display area 2a. To be more specific, when center position C1 of area 3d can be within center-position range R1 under the display-position constraint of meter 1, screen generator 18 causes the center part of area 3d in the predetermined direction to be positioned in the center part of the first target area in display area 2a. In the present example as described, the display-position constraint includes a constraint on the range within which center position C1 of area 3d in the predetermined direction is located. Thus, area 3d is placed to satisfy the display-position constraint. More specifically, center position C1 of area 3d is located within range R1. At this time, center position C1 of meter 1 may be placed in a position corresponding to the position of center position C2 of meter 2. Here, the areas other than area 3d in display area 2a (or more specifically, areas 4d, 5d, 6d, and 7d) correspond to the first extra area.

Furthermore, under the display-position constraints of navigation 1 and video 1, screen generator 18 determines to place area 4d and area 5d allocated, respectively, to navigation 1 and video 1 in the first extra area of display area 2a. Navigation 1 and video 1 are different from meter 2 and are non-priority applications having priorities not higher than the priority of meter 2. To be more specific, to place area 4d (or 5d) in the first extra area, screen generator 18 causes area 4d (or 5d) having the same size as area 4c (or 5c) that was allocated to navigation 1 (or video 1) to be in a position corresponding to the position in which area 4c (or 5c) was placed. Note that the display-position constraint may include a constraint on a positional relationship between the second areas, for example. To be more specific, the display-position constraint may include a constraint that a positional relationship between area 4d and area 5d corresponds to a positional relationship between area 4c and area 5c. In this case, area 4d can be placed adjacent to the one side of area 5d in the predetermined direction, and area 5d can be placed adjacent to the other side of area 4d in the predetermined direction.

Furthermore, screen generator 18 determines whether there are applications that are placeable in extra area 2e (the second extra area) and extra area 2f (the second extra area) of display area 2a that are areas where none of area 3d, area 4d, and area 5d is placed. Screen generator 18 determines whether applications 12 other than meter 1, navigation 1, and video 1 include applications 12 (the third applications) that are included in the application information illustrated in FIG. 5 and that satisfy the display-position constraints. Screen generator 18 makes this determination in order of priorities of such applications 12. In this case, extra areas 2e and 2f are unable to provide an area required to display the extension of video 1 that has the next highest priority. For this reason, screen generator 18 determines not to place the extension of video 1. The required area for Music having the next highest priority after the extension of video 1 satisfies area 7d (the third area) that is placeable in extra area 2f. Thus, screen generator 18 places area 7d in extra area 2f. Furthermore, the required area for Message satisfies area 6d (the third area) that is placeable in extra area 2e. Thus, screen generator 18 places area 6d in extra area 2e. In this case, extra area 2e, extra area 2f, area 6d, and area 7d have the same size. For this reason, screen generator 18 may determine to place area 7d in extra area 2e and place area 6d in extra area 2f.

In operation example 2, display area 2a after the trigger operation includes: area 3d displaying screen 31 displayed by meter 1; area 4d displaying screen 40 displayed by navigation 1; area 5d displaying screen 50 displayed by video 1; area 6d displaying screen 60 displayed by Message; and area 7d displaying screen 70 displayed by music 1. In operation example 2, when the screen displayed by the application that is to be changed is larger than the screen displayed by the application that is to be used after the change, the center position of the screen displayed by the application before the change corresponds to the center position of the screen displayed by the application after the change. With this, it seems to the user that the display position of the meter has not been changed. Furthermore, the applications that were not displayed before the change are displayed in the second extra areas to provide more information to the user.

### Operation Example 3

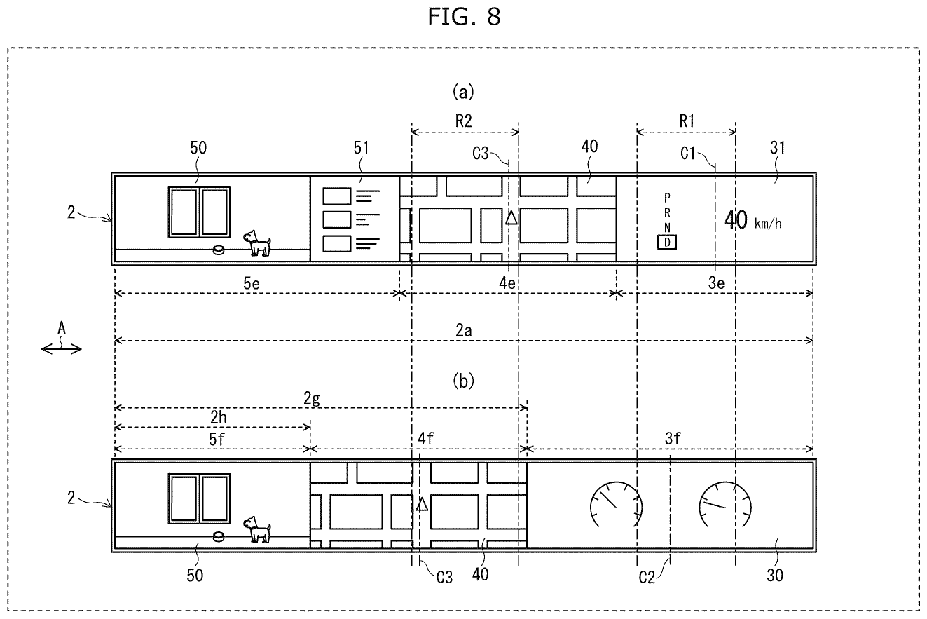

In (a) of FIG. 8, a plurality of areas 3e, 4e, and 5e (the at least one first area) are laid out. Screen 31 displayed by meter 1 is placed in area 3e. Screen 40 displayed by navigation 1 is placed in area 4e. Screen 50 displayed by video 1 and screen 51 displayed by the extension of video 1 are placed in area 5e. In (b) of FIG. 8, a plurality of areas including area 3f (the second target area), area 4f (the non-priority area), and area 5f (the non-priority area) are laid out. Screen 30 displayed by meter 1 is placed in area 3f. Screen 40 is placed in area 4f. Screen 50 is placed in area 5f. Operation example 3 performed by display control device 10 is next described with reference to FIG. 8.

FIG. 8 is a diagram illustrating an operation example where the user performs an operation to change the application for displaying the meter from meter 1 to meter 2. In the present example, the trigger operation is performed to change screen 31 displayed by meter 1, to which area 3e was allocated, to screen 30 displayed by meter 2 and different in size from screen 31 (area 3e).

Operation example 3 is different from operation example 1 mainly in the following respects.

As illustrated in (a) of FIG. 8, a plurality of areas 3e, 4e, and 5e are arranged in the predetermined direction. Area 3e is the farthest to the one side in the predetermined direction, among the plurality of areas 3e, 4e, and 5e. The plurality of areas 3e, 4e, and 5e are arranged across the whole of display area 2a.

When the plurality of areas 3e, 4e, and 5e are laid out in display area 2a and screen manager 17 obtains the operation information, screen generator 18 determines whether the in-vehicle device includes information on screen 30. Based on the application information, it is determined that the in-vehicle device includes the information on screen 30 of meter 2. Furthermore, it is determined that although meter 2 for displaying screen 30 is of the same type as meter 1 that is one of the first applications, screen 30 is different in size from screen 31. Thus, screen generator 18 determines to reset the layout. Meter 2 has the highest priority among meter 2, navigation 1, video 1, and the extension of video 1. Thus, screen generator 18 determines whether to place area 3f required to display screen 30 in display area 2a. For example, display area 2a is larger than area 3f, and thus screen generator 18 determines to place area 3f in display area 2a. Note that whether to place area 3f in display area 2a may be determined by determining whether the placement of area 3f satisfies the display-position constraint, as in operation example 4 for instance.

When determining to place area 3f in display area 2a, screen generator 18 places area 3f in display area 2a as illustrated in (b) of FIG. 8. In the present example, area 3f is larger than the first target area in which area 3e was placed. Thus, screen generator 18 causes area 3f to include the first target area in display area 2a and also causes center position C2 of area 3f to be within center-position range R1 under the display-position constraint of meter 2. To be more specific, screen generator 18 causes the end part on the one side of area 3f in the predetermined direction to be positioned at the end part on the one side of the first target area in display area 2a. In the present example as described, the display-position constraint includes a constraint on the range within which center position C2 of area 3f in the predetermined direction is located. Thus, area 3f is placed to satisfy the display-position constraint. More specifically, center position C2 of area 3f is located within range R1. Here, extra area 2g corresponds to the first extra area in display area 2a.

Among navigation 1, video 1, and the extension of video 1 that are the non-priority applications, navigation 1 has the highest priority. Thus, screen generator 18 first determines to place navigation 1. Under the display-position constraint, center position C3 of area 4f allocated to navigation 1 to which area 4e adjacent to area 3e was allocated can be within center-position range R2. Thus, screen generator 18 determines to place area 4f in display area 2a. To be more specific, screen generator 18 causes the end part on the one side of area 4f in the predetermined direction to be positioned at the end part on the one side of extra area 2g in display area 2a. In the present example as described, whether to place area 4f in display area 2a is determined based on whether the placement of area 4f satisfies the display-position constraint. Screen generator 18 determines whether the placement of area 4f satisfies the display-position constraint. When determining that the placement of area 4f satisfies the display-position constraint, screen generator 18 determines to place area 4f in display area 2a. The display-position constraint includes a constraint on the range within which center position C3 of area 4f in the predetermined direction is located. Thus, center position C3 of area 4f is located within range R2. Note that the display-position constraint may include a constraint on a positional relationship between the second target area and the second area, for example. To be more specific, the display-position constraint may include a constraint that a positional relationship between area 3f and area 4f corresponds to a positional relationship between area 3e and area 4e. In this case, area 4f can be placed adjacent to the other side of area 3f in the predetermined direction.

Screen generator 18 determines whether to place screen 50 for video 1 having the next highest priority after navigation 1. To be more specific, display area 2a includes extra area 2g where area 3f is not placed, and extra area 2g includes extra area 2h where area 4f is not placed. Thus, for video 1 having the display constraint that video 1 is placed in the passenger seat area, screen generator 18 places, in extra area 2h, area 5f having the same size as extra area 2h. Furthermore, display area 2a has no extra area after area 5f is placed. Thus, screen generator 18 determines not to place the extension of video 1. In the present example as described, whether to place area 5f in display area 2a is determined based on whether the placement of area 5f satisfies the display-position constraint. Screen generator 18 determines whether the placement of area 5f satisfies the display-position constraint. When determining that the placement of area 5f satisfies the display-position constraint, screen generator 18 determines to place area 5f in display area 2a. Area 5f is placed to satisfy the display-position constraint.

In operation example 3, display area 2a after the trigger operation includes: area 3f displaying screen 30 displayed by meter 2; area 4f displaying screen 40 displayed by navigation 1; and area 5f displaying screen 50 displayed by video 1.

Note that when the required area is different in size from the second target area or the second area, screen generator 18 may enlarge or reduce the screen displayed by the first application or the second application. For example, when the required area for video 1 is smaller than area 5f, screen generator 18 may enlarge the screen displayed by video 1 to the size of area 5f. For example, when the required area for video 1 is larger than area 5f, screen generator 18 may reduce the screen displayed by video 1 to the size of area 5f.

### Operation Example 4

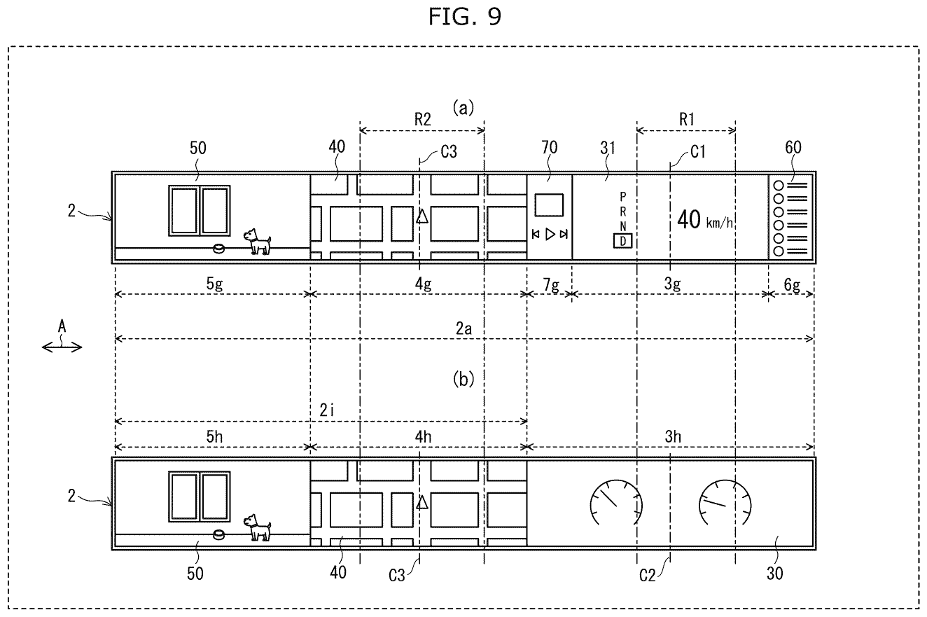

In (a) of FIG. 9, a plurality of areas 3g, 4g, 5g, 6g, and 7g (the at least one first area) are laid out. Screen 31 displayed by meter 1 is placed in area 3g. Screen 40 displayed by navigation 1 is placed in area 4g. Screen 50 displayed by video 1 is placed in area 5g. Screen 60 displayed by Message is placed in area 6g. Screen 70 displayed by music 1 is placed in area 7g. In (b) of FIG. 9, a plurality of areas including area 3h (the second target area), area 4h (the non-priority area), and area 5h (the non-priority area) are laid out. Screen 30 displayed by meter 2 is placed in area 3h. Screen 40 is placed in area 4h. Screen 50 is placed in area 5h. Operation example 4 performed by display control device 10 is next described with reference to FIG. 9.

FIG. 9 is a diagram illustrating an operation example where applications 12 illustrated in FIG. 5 include meter 1, navigation 1, video 1, music 1, and Message as the first applications and meter 2 as the second application.

FIG. 9 is a diagram illustrating the operation example where the user performs an operation to change the application for displaying the meter from meter 1 to meter 2. In this case, navigation 1, video 1, Message, and music 1 are the non-priority applications because of their respective priorities lower than the priority of meter 2.

In the present example, the trigger operation is performed to change screen 31 displayed by meter 1, to which area 3g was allocated, to screen 30 displayed by meter 2 and different in size from screen 31.

Operation example 4 is different from operation example 3 mainly in the following respects.

When the plurality of areas 3g, 4g, 5g, 6g, and 7g are laid out in display area 2a and screen manager 17 obtains the operation information, screen generator 18 determines whether the in-vehicle device includes information on screen 30. Based on the application information, it is determined that the in-vehicle device includes the information on screen 30 of meter 2. Furthermore, it is determined that although meter 2 for displaying screen 30 is of the same type as meter 1 that is one of the first applications, screen 30 is different in size from screen 31. Thus, screen generator 18 determines to reset the layout. Meter 2 has the highest priority among meter 2, navigation 1, video 1, music 1, and Message. Thus, screen generator 18 determines whether to place area 3h required to display screen 30 in display area 2a. For example, whether to place area 3h in display area 2a is determined based on whether the placement of area 3h satisfies the display-position constraint of area 3h. The display-position constraint includes a constraint on the range within which center position C2 of area 3h in the predetermined direction is located. When determining that center position C2 of area 3h can be within range R1, screen generator 18 determines to place area 3h in display area 2a. Note that screen generator 18 may determine to place area 3h in display area 2a because display area 2a is larger than area 3h, as in operation example 3 for instance.

When determining to place area 3h in display area 2a, screen generator 18 places area 3h in display area 2a as illustrated in (b) of FIG. 9. In the present example, area 3h is larger than the first target area in which area 3g was placed. Thus, screen generator 18 causes area 3h to include the first target area in display area 2a and also causes center position C2 of area 3h to be within range R1 under the display-position constraint of meter 2. In the present example as described, the display-position constraint includes a constraint on the range within which center position C2 of area 3h in the predetermined direction is located. Thus, area 3h is placed to satisfy the display-position constraint. More specifically, center position C2 of area 3h is located within range R1. At this time, center position C1 of meter 1 may be placed in a position corresponding to the position of center position C2 of meter 2. Here, the areas other than area 3h in display area 2a correspond to the first extra area (extra area 2i).

Furthermore, among the plurality of applications 12 (the at least one first application) to which the plurality of areas 3g, 4g, 5g, 6g, and 7g were allocated, screen generator 18 places applications 12 (the at least one non-priority application) different in type from meter 2 to which area 3h is allocated, in extra area 2i in order of priorities of applications 12. To be more specific, screen generator 18 allocates areas of extra area 2i to navigation 1 having the second highest priority and then to video 1 having the third highest priority. Screen generator 18 places area 4h (or 5h) having the same size as area 4g (or 5g) allocated to the corresponding application, under the corresponding display-position constraint. In this case, the size of extra area 2i is equal to the total size of areas 4g and 5g. Thus, area 4h (or 5h) is placed, in extra area 2i, in a position corresponding to the position in which area 4g (or 5g) was placed. Note that the display-position constraint may include a constraint on a positional relationship between the second areas, for example. To be more specific, the display-position constraint may include a constraint that a positional relationship between area 4h and area 5h corresponds to a positional relationship between area 4g and area 5g. In this case, area 4h can be placed adjacent to the one side of area 5h in the predetermined direction, and area 5h can be placed adjacent to the other side of area 4h in the predetermined direction.

As illustrated in (b) of FIG. 9, display area 2a has no extra area after areas 3h, 4h, and 5h are placed. Thus, screen generator 18 determines to place neither Message to which area 6g was allocated nor music 1 to which area 7g was allocated.

In operation example 4, display area 2a after the trigger operation includes: area 3h displaying screen 30 displayed by meter 2; area 4h displaying screen 40 displayed by navigation 1; and area 5h displaying screen 50 displayed by video 1. In operation example 4, when the area allocated to the application that is to be used after the change is larger than the area allocated to the application that is to be changed, the applications having low priorities are not displayed.

Note that when the required area is different in size from the second target area or the second area, screen generator 18 may enlarge or reduce the screen displayed by the first application or the second application. For example, when the required area for video 1 is smaller than area 5h, screen generator 18 may enlarge the screen displayed by video 1 to the size of area 5h. For example, when the required area for video 1 is larger than area 5h, screen generator 18 may reduce the screen displayed by video 1 to the size of area 5h.

Display control device 10 according to the present embodiment includes screen manager 17 and screen generator 18. Screen manager 17 obtains operation information indicating that a trigger operation was performed, the trigger operation triggering placement of a second target area in display area 2a that is included in display 2 disposed in vehicle 1 and that includes at least one first area allocated to at least one first application, the second target area being allocated to a second application different from the at least one first application and being different from the at least one first area. Screen generator 18: determines, when screen manager 17 obtains the operation information, whether to place the second target area in display area 2a; places, when determining to place the second target area in display area 2a, the second target area in display area 2a without placing the at least one first area in display area 2a; determines, when determining to place the second target area in display area 2a in the presence of a first application that is included among the at least one first application and that is different in type from the second application, whether to place a second area allocated to the first application in display area 2a; and places, when determining to place the second area in display area 2a, the second area in display area 2a.

With this, the second area that is allocated to the second application different from the at least one first application and that is different from the at least one first area is placeable in display area 2a. This allows display area 2a to be used more appropriately. Furthermore, the second area allocated to the first application that is included among the at least one first application and that is different in type from the second application is placeable in display area 2a. This allows display area 2a to be used more appropriately.

Furthermore, in display control device 10 according to the present embodiment, each of the at least one first application and the second application is assigned a priority. Screen generator 18: determines, when the at least one first application includes a priority application that is a first application having the priority higher than the priority of the second application, whether the second target area and a priority area that is the second area allocated to the priority application are placeable in display area 2a; determines, when determining that the priority area and the second target area are placeable in display area 2a, to place the priority area and the second target area in display area 2a; and when determining that the priority area and the second target area are not placeable in display area 2a, determines not to place the priority area and the second target area in display area 2a and places the at least one first area in display area 2a.

With this, when the priority area and the second target area are placeable in display area 2a, the priority area and the second target area are placed in display area 2a. When the priority area and the second target area are not placeable in display area 2a, the at least one first area is placed in display area 2a instead of placing the priority area and the second target area in display area 2a. This allows display area 2a to be used even more appropriately.

Furthermore, in display control device 10 according to the present embodiment, screen generator 18: determines, when the at least one first application includes a non-priority application that is a first application having the priority that is not higher than the priority of the second application, whether a non-priority area that is the second area allocated to the non-priority application is placeable in a first extra area that is included in display area 2a and in which neither the priority area nor the second target area is placed; and determines, when determining that the non-priority area is placeable in the first extra area, to place the non-priority area in the first extra area.

With this, when the non-priority area is placeable in the first extra area, the non-priority area is placed in the first extra area. This allows display area 2a to be used even more appropriately.

Furthermore, in display control device 10 according to the present embodiment, when display area 2a includes a second extra area in which none of the priority area, the second target area, and the non-priority area is placed and there is a third application other than the at least one first application and the second application, screen generator 18 determines whether a third area allocated to the third application is placeable in the second extra area and places the third area in the second extra area when determining that the third area is placeable in the second extra area.

With this, when the third area is placeable in the second extra area, the third area is placed in the second extra area. This allows display area 2a to be used even more appropriately.

Furthermore, in display control device 10 according to the present embodiment, the trigger operation is performed to replace a first application among the at least one first application with the second application that is of the same type as the first application. The second target area is smaller than a first target area in which the first area allocated to the first application was placed. When determining to place the second target area in display area 2a, screen generator 18 causes the second target area to be included in the first target area in display area 2a.

With this, the second target area that is smaller than the first target area can be placed to be included in the first target area.

Furthermore, in display control device 10 according to the present embodiment, the trigger operation is performed to replace a first application among the at least one first application with the second application that is of a same type as the first application. The second target area is larger than a first target area in which the first area allocated to the first application was placed. When determining to place the second target area in display area 2a, screen generator 18 causes the first target area to be included in the second target area in display area 2a.

With this, the second target area that is larger than the first target area can be placed to include the first target area.

Furthermore, in display control device 10 according to the present embodiment, each of the at least one first application and the second application has a display-position constraint. Whether to place the second target area or the second area in display area 2a is determined based on whether placement of the second target area or the second area in display area 2a satisfies the display-position constraint.

With this, when the placement of the second target area or the second area satisfies the display-position constraint, the second target area or the second area is placeable in display area 2a. This allows display area 2a to be used even more appropriately.

Furthermore, in display control device 10 according to the present embodiment, the at least one first area comprises a plurality of first areas arranged in a predetermined direction. The display-position constraint is a constraint on a range within which a center position of the second target area or the second area in the predetermined direction is located.

With this, when the placement of the second target area or the second area satisfies the constraint on the range within which the center position of the second target area or the second area in the predetermined direction is located, the second target area or the second area is placeable in display area 2a. This allows display area 2a to be used even more appropriately.

Furthermore, in display control device 10 according to the present embodiment, the display-position constraint is a constraint on a positional relationship between the second target area and the second area or a positional relationship between the second area and the second area.

With this, when the placement of the second target area or the second area satisfies the constraint on the positional relationship between the second target area and the second area or the positional relationship between the second areas, the second target area or the second area is placeable in display area 2a. This allows display area 2a to be used even more appropriately.

Furthermore, in display control device 10 according to the present embodiment, each of the at least one first application and the second application has a required area that indicates an area size required for displaying. When the required area is different in size from the second target area or the second area, screen generator 18 enlarges or reduces a screen displayed by the first application or the second application before displaying the screen.

With this, when the required area is different in size from the second target area or the second area, the screen displayed by the first application or the second application can be enlarged or reduced before being displayed. This allows display area 2a to be used even more appropriately.

Furthermore, for display control device 10 according to the present embodiment, vehicle 1 includes: a driver seat on one side with respect to a central part of vehicle 1 in a transverse direction; and a passenger seat on the other side with respect to the central part of vehicle 1 in the transverse direction. The predetermined direction is the transverse direction. Display area 2a is: located farther forward than the driver seat and the passenger seat in a longitudinal direction of vehicle 1; located in front of the driver seat and the passenger seat, extending from a position corresponding to the driver seat to a position corresponding to the passenger seat in the transverse direction; and disposed to face rearward in the longitudinal direction.

This allows the second target area to be easy to see for a driver of vehicle 1 and allows the second area to be easy to see for a passenger of vehicle 1.

A display control method according to the present embodiment includes: obtaining operation information indicating that a trigger operation was performed, the trigger operation triggering placement of a second target area in display area 2a that is included in display 2 disposed in vehicle 1 and that includes at least one first area allocated to at least one first application, the second target area being allocated to a second application different from the at least one first application and being different from the at least one first area (Step S1); determining, when the operation information is obtained in the obtaining, whether to place the second target area in display area 2a (Steps S8 and S9); placing, when determining to place the second target area in display area 2a, the second target area in display area 2a without placing the at least one first area in display area 2a (Step S20); determining, when determining to place the second target area in display area 2a in the presence of a first application that is included among the at least one first application and that is different in type from the second application, whether to place a second area allocated to the first application in display area 2a (Step S15); and placing, when determining to place the second area in display area 2a, the second area in display area 2a (Step S20).

With this, the same operational effects as those achieved by display control device 10 described above can be achieved.

Furthermore, the program according to the present embodiment is a program for causing a computer to execute the display control method described above.

With this, the same operational effects as those achieved by display control device 10 described above can be achieved.

### OTHER EMBODIMENTS

Although a display control device according to one or more aspects of the present disclosure has been described based on an embodiment, the present disclosure is not limited to this embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

Although display 2 is a display in Embodiment described above, this is not intended to be limiting. For example, display 2 may include a plurality of displays, and thus a display area of display 2 may include a plurality of display screens of the plurality of displays.

Furthermore, although the area is rectangular in Embodiment described above, this is not intended to be limiting. For example, the area may be circular or triangular.

Furthermore, although the display-position constraint is put on, for example, the center-position range and the adjacency relationship between the specific applications in Embodiment described above, this is not intended to be limiting. For example, the display-position constraint may be that the second area is not adjacent to the second target area or that the second area is in a predetermined position in the display area.

Furthermore, although the vertical dimension of an area required for an application is equal to the vertical dimension of display area 2a in Embodiment described above, this is not intended to be limiting. For example, when the vertical dimension of the area to be placed is smaller than the vertical dimension of display area 2a and an extra area is left below the area placed, another application may be placed below the area placed. More specifically, instead of placing only one application in the vertical direction of the display area, a plurality of applications may be placed in the vertical direction. Alternatively, to place the application in display area 2a, the vertical dimension of the required area for the application may be enlarged to the vertical dimension of display area 2a. Furthermore, when the required area for the application is larger than the vertical dimension or the transverse dimension of an area for which whether the application is placeable is determined, the required area may be reduced to the size of the area.

Furthermore, although the plurality of areas in display area 2a can be allocated without leaving any extra area in Embodiment described above, this is not intended to be limiting. For example, when there is no application that can be displayed in an extra area of display area 2a due to the display-position constraint, a background image in a predetermined color or design may be displayed in this extra area.

Furthermore, although only one among the applications of the same type with the same priority is placed in Embodiment described above, this is not intended to be limiting. The applications of the same type with the same priority may be placed.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory. Software implementing the device or the like described in the above embodiments is a program for causing a computer to execute the steps included in the flowcharts shown in FIGS. 3 and 4.

It should be noted that the present disclosure may also include the following embodiments.

(1) Each of one or more devices described above may specifically be a computer system including, for example, a microprocessor, ROM (Read Only Memory), and RAM (Random Access Memory), a hard disk unit, a display unit, a keyboard, a mouse, and the like. The RAM or the hard disk unit holds a computer program. The microprocessor operates according to the computer program to cause each of the one or more devices described above to execute its function. Here, the computer program includes combinations of instruction codes for issuing instructions to the computer to execute predetermined functions.

(2) A part or all of constituent elements in each of the one or more devices described above may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. The microprocessor operates according to the computer program to cause the system LSI to execute its function.

(3) A part or all of the constituent elements included in each of the one or more devices described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.

(4) The present disclosure may be the above-described methods. These methods may be a computer program executed by a computer, or digital signals forming the computer program.

The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray (registered trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

The present disclosure may be a computer system including a microprocessor and a memory. The memory stores the computer program and the microprocessor operates according to the computer program.

It is also possible that the program or the digital signals may be recorded onto the recording medium to be transferred, or may be transmitted via a network or the like, so that the program or the digital signals can be executed by a different independent computer system.

(5) Furthermore, the above-described embodiments and the other embodiments may be combined.

### APPENDIX

The above-described embodiments disclose the following techniques.

### Technique 1

A display control device including:
an obtainer that obtains operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area; and
a controller that
   determines, when the operation information is obtained by the obtainer, whether to place the second target area in the display area,
   places, when the second target area is determined to be placed in the display area, the second target area in the display area without placing the at least one first area in the display area,
   determines, when the second target area is determined to be placed in the display area in presence of a first application that is included among the at least one first application and that is different in type from the second application, whether to place a second area allocated to the first application in the display area, and
   places, when the second area is determined to be placed in the display area, the second area in the display area.

### Technique 2

The display control device according to Technique 1,
wherein each of the at least one first application and the second application is assigned a priority, and
the controller
determines, when the at least one first application includes a priority application that is a first application having the priority higher than the priority of the second application, whether the second target area and a priority area that is the second area allocated to the priority application are placeable in the display area,
determines, when determining that the priority area and the second target area are placeable in the display area, to place the priority area and the second target area in the display area, and
when determining that the priority area and the second target area are not placeable in the display area, determines not to place the priority area and the second target area in the display area and places the at least one first area in the display area.

### Technique 3

The display control device according to Technique 2,
wherein the controller
determines, when the at least one first application includes a non-priority application that is a first application having the priority that is not higher than the priority of the second application, whether a non-priority area that is the second area allocated to the non-priority application is placeable in a first extra area that is included in the display area and in which neither the priority area nor the second target area is placed, and
determines, when determining that the non-priority area is placeable in the first extra area, to place the non-priority area in the first extra area.

### Technique 4

The display control device according to Technique 3,
wherein when the display area includes a second extra area in which none of the priority area, the second target area, or the non-priority area is placed in presence of a third application other than the at least one first application and the second application,
the controller determines whether a third area allocated to the third application is placeable in the second extra area and places the third area in the second extra area when the third area is determined placeable in the second extra area.

### Technique 5

The display control device according to Technique 3 or 4,
wherein the trigger operation is performed to replace a first application among the at least one first application with the second application that is of a same type as the first application,
the second target area is smaller than a first target area in which the first area allocated to the first application was placed, and
when the second target area is determined to be placed in the display area, the controller causes the second target area to be included in the first target area in the display area.

### Technique 6

The display control device according to Technique 3 or 4,
wherein the trigger operation is performed to replace a first application among the at least one first application with the second application that is of a same type as the first application,
the second target area is larger than a first target area in which the first area allocated to the first application was placed, and
when the second target area is determined to be placed in the display area, the controller causes the first target area to be included in the second target area in the display area.

### Technique 7

The display control device according to any one of Techniques 1 to 6,
wherein each of the at least one first application and the second application has a display-position constraint, and
whether to place the second target area or the second area in the display area is determined based on whether placement of the second target area or the second area in the display area satisfies the display-position constraint.

### Technique 8

The display control device according to Technique 7,
wherein the at least one first area comprises a plurality of first areas arranged in a predetermined direction, and
the display-position constraint is a constraint on a range within which a center position of the second target area or the second area in the predetermined direction is located.

### Technique 9

The display control device according to Technique 7,
wherein the display-position constraint is a constraint on a positional relationship between the second target area and the second area or a positional relationship between second areas each being the second area.

### Technique 10

The display control device according to any one of Techniques 1 to 9,
wherein each of the at least one first application and the second application has a required area that indicates an area size required for displaying, and
when the required area is different in size from the second target area or the second area, the controller enlarges or reduces a screen to be displayed by the first application or the second application.

### Technique 11

The display control device according to Technique 8,
wherein the vehicle includes: a driver seat on one side with respect to a central part of the vehicle in a transverse direction of the vehicle; and a passenger seat on an other side with respect to the central part of the vehicle in the transverse direction,
the predetermined direction is the transverse direction, and
the display area is: located farther forward than the driver seat and the passenger seat in a longitudinal direction of the vehicle; located in front of the driver seat and the passenger seat, extending from a position corresponding to the driver seat to a position corresponding to the passenger seat in the transverse direction; and disposed to face rearward in the longitudinal direction.

### Technique 12

A display control method including:
obtaining operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area;
determining, when the operation information is obtained in the obtaining, whether to place the second target area in the display area;
placing, when the second target area is determined to be placed in the display area, the second target area in the display area without placing the at least one first area in the display area;
determining, when the second target area is determined to be placed in the display area in presence of a first application that is included among the at least one first application and that is different in type from the second application, whether to place a second area allocated to the first application in the display area; and
placing, when the second area is determined to be placed in the display area, the second area in the display area.

### Technique 13

A program for causing a computer to execute the display control method according to Technique 12.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. Japanese Patent Application No. 2024-041272 filed on Mar. 15, 2024.

### INDUSTRIAL APPLICABILITY

The present disclosure is applicable to, for example, a device that controls displaying of an image onto a display disposed in a vehicle.

1. A display control device comprising:
a memory; and
a processor that is connected to the memory,
wherein the processor
obtains operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area,
determines, when the operation information is obtained, whether to place the second target area in the display area,
places, when the second target area is determined to be placed in the display area, the second target area in the display area without placing the at least one first area in the display area,
determines, when the second target area is determined to be placed in the display area in presence of a first application that is included among the at least one first application and that is different in type from the second application, whether to place a second area allocated to the first application in the display area, and
places, when the second area is determined to be placed in the display area, the second area in the display area.

2. The display control device according to claim 1,
wherein each of the at least one first application and the second application is assigned a priority, and
the processor
determines, when the at least one first application includes a priority application that is a first application having the priority higher than the priority of the second application, whether the second target area and a priority area that is the second area allocated to the priority application are placeable in the display area,
determines, when determining that the priority area and the second target area are placeable in the display area, to place the priority area and the second target area in the display area, and
when determining that the priority area and the second target area are not placeable in the display area, determines not to place the priority area and the second target area in the display area and places the at least one first area in the display area.

3. The display control device according to claim 2,
wherein the processor
determines, when the at least one first application includes a non-priority application that is a first application having the priority that is not higher than the priority of the second application, whether a non-priority area that is the second area allocated to the non-priority application is placeable in a first extra area that is included in the display area and in which neither the priority area nor the second target area is placed, and
determines, when determining that the non-priority area is placeable in the first extra area, to place the non-priority area in the first extra area.

4. The display control device according to claim 3,
wherein when the display area includes a second extra area in which none of the priority area, the second target area, or the non-priority area is placed in presence of a third application other than the at least one first application and the second application,
the processor determines whether a third area allocated to the third application is placeable in the second extra area and places the third area in the second extra area when the third area is determined placeable in the second extra area.

5. The display control device according to claim 3,
wherein the trigger operation is performed to replace a first application among the at least one first application with the second application that is of a same type as the first application,
the second target area is smaller than a first target area in which the first area allocated to the first application was placed, and
when the second target area is determined to be placed in the display area, the processor causes the second target area to be included in the first target area in the display area.

6. The display control device according to claim 3,
wherein the trigger operation is performed to replace a first application among the at least one first application with the second application that is of a same type as the first application,
the second target area is larger than a first target area in which the first area allocated to the first application was placed, and
when the second target area is determined to be placed in the display area, the processor causes the first target area to be included in the second target area in the display area.

7. The display control device according to claim 1,
wherein each of the at least one first application and the second application has a display-position constraint, and
whether to place the second target area or the second area in the display area is determined based on whether placement of the second target area or the second area in the display area satisfies the display-position constraint.

8. The display control device according to claim 7,
wherein the at least one first area comprises a plurality of first areas arranged in a predetermined direction, and
the display-position constraint is a constraint on a range within which a center position of the second target area or the second area in the predetermined direction is located.

9. The display control device according to claim 7,
wherein the display-position constraint is a constraint on a positional relationship between the second target area and the second area or a positional relationship between second areas each being the second area.

10. The display control device according to claim 1,
wherein each of the at least one first application and the second application has a required area that indicates an area size required for displaying, and
when the required area is different in size from the second target area or the second area, the processor enlarges or reduces a screen to be displayed by the first application or the second application.

11. The display control device according to claim 8,
wherein the vehicle includes: a driver seat on one side with respect to a central part of the vehicle in a transverse direction of the vehicle; and a passenger seat on an other side with respect to the central part of the vehicle in the transverse direction,
the predetermined direction is the transverse direction, and
the display area is: located farther forward than the driver seat and the passenger seat in a longitudinal direction of the vehicle; located in front of the driver seat and the passenger seat, extending from a position corresponding to the driver seat to a position corresponding to the passenger seat in the transverse direction; and disposed to face rearward in the longitudinal direction.

12. A display control method executed by a computer, the display control method comprising:
obtaining operation information indicating that a trigger operation has been performed, the trigger operation triggering placement of a second target area in a display area that is included in a display disposed in a vehicle and that includes at least one first area allocated to at least one first application, the second target area being allocated to a second application different from the at least one first application and being different from the at least one first area;
determining, when the operation information is obtained in the obtaining, whether to place the second target area in the display area;
placing, when the second target area is determined to be placed in the display area, the second target area in the display area without placing the at least one first area in the display area;
determining, when the second target area is determined to be placed in the display area in presence of a first application that is included among the at least one first application and that is different in type from the second application, whether to place a second area allocated to the first application in the display area; and
placing, when the second area is determined to be placed in the display area, the second area in the display area.
